(19) United States
(12) Patent Application Publication
(10) Pub. No.: US 2026/0262042 A1
(43) Pub. Date: Sep. 3, 2026

(54) UPLINK CONTROL INFORMATION MULTIPLEXING ENHANCEMENT FOR UP TO EIGHT ANTENNA PORT TRANSMIT UPLINK OPERATION

(71) Applicant: APPLE INC., Cupertino, CA (US)

(72) Inventors: Haitong Sun, Cupertino, CA (US); Chunxuan Ye, San Diego, CA (US); Seyed Ali Akbar Fakoorian, San Diego, CA (US); Wei Zeng, San Diego, CA (US); Dawei Zhang, Saratoga, CA (US); Sigen Ye, San Diego, CA (US)

(21) Appl. No.: 19/165,259

(22) PCT Filed: Mar. 29, 2024
(86) PCT No.: PCT/US2024/022306

§ 371 Date: Sep. 15, 2025

Related U.S. Application Data
(60) Provisional application No. 63/494,030, filed on Apr. 4, 2023.

(51) Int. Cl. H04W 72/21; H04L 1/00; H04L 5/00

(52) U.S. Cl. CPC H04W 72/21; H04L 1/0003; H04L 5/0055

(57) ABSTRACT

Systems and methods using uplink control information multiplexing enhancements for up to eight antenna port transmit (Tx) uplink operations are discussed. A wireless communication system supports the use of two codewords in a single physical uplink shared channel (PUSCH) sent by a user equipment (UE) to a network, where the PUSCH is sent with a rank that is greater than four (e.g., using more than four layers). Herein, various examples are provided with respect to manners of encoding uplink control information (UCI) to be multiplexed into one or more of the two codewords, manners of using beta offsets for UCI multiplexing into one or more of the two codewords, manners of using scaling factors for UCI multiplexing with one or more of the two codewords, and/or manners of identifying a single one of the codewords for UCI multiplexing use/extraction. Different treatments based on UCI types within these contexts are discussed.

### TECHNICAL FIELD

This application relates generally to wireless communication systems, including wireless communication systems implementing UCI multiplexing enhancements for up to 8 layer transmit (Tx) uplink (UL) operations.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of a UE, according to embodiments herein.

FIG. 2 illustrates a method of a RAN, according to embodiments herein.

FIG. 3 illustrates a method of a UE, according to embodiments herein.

FIG. 4 illustrates a method of a RAN, according to embodiments herein.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In various wireless communication systems, different modes may be supported for uplink (UL) multiple input multiple output (MIMO) operation. For example, codebook-based physical uplink shared channel (PUSCH) operation may be supported. In such cases, a precoding and number of layers to be used by the UE for the PUSCH may be indicated to the UE by the network using a “precoding information and number of layers” field in a downlink control information (DCI) that schedules the PUSCH. The possible precoders that may be so indicated may be hardcoded per a specification for the wireless communication system. In some wireless communication systems, such hardcoded precoders may correspond to/be indicated by a transmit precoding matrix indicator (TPMI). See, e.g., 3GPP Technical Specification (TS) 38.212, version 17.4.0 (December 2022).

In another example, non-codebook-based PUSCH operation may be supported. In such cases, a precoding and number of layers to be used by the UE for the PUSCH may be indicated to the UE by the network using a sounding reference signal (SRS) resource indicator (SRI) field in the DCI that schedules the PUSCH.

In some wireless communication systems implementing NR, for codebook UL MIMO operation, various coherency modes are supported. These may include, for example: a non-coherent mode that corresponds to the use of a first subset of codebook-based precoders that are useable in the case that there is no coherency between antenna ports used at the UE for the PUSCH; a partial coherent mode that corresponds to the use of a second subset of codebook-based precoders that are usable in the case that there is coherency between some, but not all, of the antenna ports used at the UE for the PUSCH; and a fully-coherent mode that corresponds to the use of a third subset of codebook-based precoders that are usable in the case that there is coherency between all of the antenna ports used at the UE for the PUSCH.

Note that current NR implementations support the use of only four antenna ports for a PUSCH, corresponding to an (up to) four layer PUSCH operation. Further, in current NR implementations, only a single codeword may be transmitted in a PUSCH.

Current NR implementations support uplink control information (UCI) multiplexing on PUSCH. In some cases, there may be three different types of UCI that may be multiplexed on the PUSCH: hybrid automatic repeat request acknowledgment (HARQ-ACK) type UCI, channel state information (CSI) type UCI (including CSI part 1 and/or CSI part 2), and configured grant uplink control information (CG-UCI) type UCI. Note that in present NR systems that only support the transmission of a single codeword in a PUSCH, all UCI that is multiplexed into the PUSCH will be multiplexed into that same (single) codeword.

Support of (up to) eight antenna port transmit (Tx) UL operation is under consideration for some wireless communication systems. Accordingly, improvements to such wireless communications systems that support the transmission of two codewords in a PUSCH may be considered. For example, in cases where an UL transmission (e.g., a PUSCH) is to be sent with a rank that is greater than four (e.g., using more than four layers), dual codewords (as opposed to the use of a single codeword) may be present in the UL transmission.

Proposals herein describe UCI multiplexing enhancements for the (up to) eight antenna port Tx UL operation use case that contemplate the transmission of PUSCHs having two codewords. Proposed enhancements herein relate to enhancements for UCI encoding mechanisms, beta offset configurations, scaling configurations, and mechanisms for identifying and mapping UCI to one of the two codewords.

### Embodiments with Respect to UCI Encoding

With respect to UCI multiplexing on a PUSCH using two codewords on more than four layers, various UCI encoding design aspect may be considered.

There may be various types of UCI that are useable within the wireless communication system. For example, there may be a HARQ-ACK type of UCI, a CSI type of UCI (which may be understood in terms of a combined CSI part 1 type of UCI and CSI part 2 type of UCI), a CG-UCI type of UCI, and/or a HARQ-ACK and CG-UCI type of UCI (which may be used when a cg-UCI-Multiplexing information element (IE) is configured).

Corresponding to enhancements discussed herein, UCI encoding designs for one or more of these UCI types may be elected according to one of a variety of options. In a first option, a single channel coding for a corresponding type of UCI may be utilized (e.g., a single encoding may be applied to the UCI).

In a second option, a UCI may be divided into two portions, where each part corresponds to (is multiplexed into) one of the two codewords of the PUSCH. In such cases, it may be that each of the two portions of the UCI may use independent channel codings (e.g., different encodings may be applied to each portion of the UCI).

It is contemplated that different types of UCI may utilize different options as just described. For example, it may be that UCI that is of type CSI part 2 is treated according to the second option (e.g., is divided into two portions that have independent channel codings applied), while another type of UCI (e.g., HARQ-ACK) may be treated according to the first option (where a single channel coding is applied).

It is contemplated that the channel codings available to encode UCI within the wireless communication system as discussed herein may include, for example, a polar encoding or other encoding methods for small block length including repetition encoding, simplex encoding, or Reed-Muller encoding.

In some embodiments contemplating a PUSCH having two codewords and sent on more than four layers, when a type of the UCI is to be divided into two portions with each part being multiplexed in different codewords of the PUSCH, the division of an (undivided) UCI into the two portions may occur according to one of various options. For example, in a first option, a UCI of the applicable type may be divided into two portions that each have roughly the same size. In a first option, if the UCI contains L bits, the first portion of the UCI may be the first floor (L/2) bits of the (undivided) UCI, and the second portion of the UCI may be the last ceil (L/2) bits of the (undivided) UCI.

In a second option, a UCI of the applicable type may be divided into two portions, with the size of each part being proportional to a size corresponding to its associated codeword. For example, in a case where the corresponding type of UCI contains L bits, the first codeword corresponds to a size K₁ and the second codeword corresponds to a size K₂, the first portion of the UCI may be the first floor (L*K₁/(K₁+K₂)) bits of the (undivided) UCI and the second portion of the UCI may be the last ceil (L*K₂/(K₁+K₂)) bits of the (undivided) UCI.

Note that the size corresponding to the associated codeword (e.g., K₁, K₂, as the case may be) can understood as either the bits allocated for the UCI within the respective codeword, or as the total number of bits allocated for the codeword.

In some embodiments contemplating a PUSCH having two codewords and sent on more than four layers, with respect to UCI multiplexing on the PUSCH, it may be that multiple UCIs having different priorities (e.g., a low priority and a high priority) are available for multiplexing. In such cases, with respect to UCI encoding, it may be that low priority UCI and high priority UCI cannot be multiplexed together within the same PUSCH. For example, in such a case where a low priority UCI and a high priority UCI are available for multiplexing, it may be that the low priority UCI is omitted/dropped. Note that while the priority of a UCI may in some cases be determined based on a priority of a PUSCH (or physical uplink control channel (PUCCH)) that carries the UCI, in other cases, the priority of the UCI may be determined based on a type of the UCI (for example, in some cases, HARQ-ACK type of UCI may have a higher priority than a CSI type of UCI).

It is contemplated that in some cases, such a restriction on multiplexing high priority UCI and low priority UCI together may be applied as a general rule (e.g., across all UCI types). It is also contemplated that in other cases, the restriction on multiplexing high priority UCI and low priority UCI may be applied selectively, based on the types of UCI in question for a given case. For example, the may be that a HARQ-ACK type of UCI that is of a low priority may nevertheless still be allowed to be multiplexed into a same PUSCH as another UCI that is of a high priority (e.g., in contexts where even a formally low priority HARQ-ACK type of UCI is understood to be generally important to system performance).

### Embodiments with Respect to Beta Offset Configuration

In some embodiments, a beta offset (also sometimes denoted as herein) may be configured by the network on a semi-static basis (e.g., via radio resource control (RRC) signaling) and/or dynamically indicated to the UE via a DCI. The UE applies an applicable beta offset in computations that determine a number of resources available to the UE for multiplexing UCI into a corresponding codeword of a PUSCH.

In some wireless communication systems, different beta offsets may be provided for use with different types of UCI. The appropriate/corresponding beta offsets are then applied by the UE when multiplexing a corresponding type of UCI into a codeword of a PUSCH. For example, a wireless communication system may contemplate the use of one or more of:

$${β}_{offset}^{HARQ - ACK} ,$$

a beta offset for a HARQ-ACK type of UCI or a HARQ-ACK and CG-UCI type of UCI;

$${β}_{offset}^{CSI - part 1} ,$$

a beta offset for a CSI part 1 type of UCI;

$${β}_{offset}^{CSI - part 2} ,$$

a beta offset for a CSI part 2 type of UCI; and/or

$${β}_{offset}^{CG - UCI} ,$$

a beta offset for a CG-UCI type of UCI.

In some embodiments contemplating a PUSCH having two codewords and sent on more than four layers, for UCI multiplexing on the PUSCH, various options may be considered with respect to an applicable beta offset configuration to use. In a first option, it may be that a same beta offset is configured by the network to be used to multiplex UCI into each of the codewords of the PUSCH.

In a second option, independent beta offsets may be configured for use with the two codewords of the PUSCH. In such cases, a first beta offset may be used to multiplex UCI into a first codeword, and a second beta offset may be used to multiplex UCI into the second codeword.

It may be that different types of UCI are treated according to different ones of the preceding options. For example, it may be that there is a single

$${β}_{offset}^{HARQ - ACK}$$

for multiplexing HARQ-ACK type UCI into each of two codewords of a PUSCH, while there are (also) a first

$${β}_{offset}^{CG - UCI}$$

used for multiplexing CG-UCI type UCI into a first codeword of a PUSCH and a second

$${β}_{offset}^{CG - UCI}$$

used for multiplexing CG-UCI type UCI into a second codeword of the PUSCH.

In some embodiments contemplating a PUSCH having two codewords and sent on more than four layers, for UCI multiplexing on the PUSCH, with respect to beta offset configuration, it may be that a dynamic beta offset indication is made (e.g., where the applicable beta offset(s) to use is/are provided to the UE in DCI that schedules the PUSCH).

In such cases, various options for making the indication(s) of the beta offset(s) are contemplated. In a first option, the scheduling DCI may provide a single beta offset that is to be used when multiplexing UCI into each of the first codeword and the second codeword of the PUSCH.

In a second option, the scheduling DCI may provide independent beta offsets for each of the codewords, where a first beta offset is to be used when multiplexing UCI into the first codeword of a PUSCH and the second beta offset is to be used when multiplexing UCI into the second codeword of the PUSCH.

Under the second option, various structural alternatives to the scheduling DCI are contemplated. In a first alternative of the second option, two beta offset indicator fields may be provided in the scheduling DCI, where a first beta offset indicator field provides a first beta offset to use with the first codeword of a PUSCH and a second beta offset indicator field provides a second beta offset to use with the second codeword of the PUSCH.

Note that corresponding to this first alternative, in cases where a scheduling DCI actually schedules a PUSCH that uses only a single codeword (e.g., a PUSCH using less than or equal to four layers), the UE may ignore the second beta offset indicator field. Further, the network/base station may additionally/alternatively indicate a reserved value in the second beta offset indicator field.

In a second alternative of the second option, a bitwidth of a single beta offset indicator field in the scheduling DCI may be of sufficient size for indicating each of the first beta offset and the second beta offset. For example, in the case that the wireless communication system is capable of indicating a beta offset using two bits, the bitwidth of the (single) beta offset indicator field in the scheduling DCI may be four bits. In such a case, the first two bits of the beta offset indicator field may be used to indicate the beta offset used with the first codeword of the PUSCH and the last two bits may be used to indicate the beta offset used with the second codeword.

Note that corresponding to this second alternative, in cases where a scheduling DCI actually schedules a PUSCH that uses only a single codeword (e.g., a PUSCH using less than or equal to four layers), the UE may ignore the last two bits of the beta offset indicator field. Further, the network/base station may additionally/alternatively indicate a reserved value in the last two bits of the beta offset indicator field.

In some embodiments contemplating a PUSCH having two codewords and sent on more than four layers, for UCI multiplexing on the PUSCH, various mechanisms for using beta offset(s) to compute number(s) of resources for multiplexing different types of UCI in a PUSCH are contemplated.

For example, taking the case that a single beta offset is provided in the scheduling DCI for use for both codewords of the PUSCH, multiple options exist. In a first option, the number of resources used for multiplexing UCI into each of the two codewords may be determined based on an application of the indicated beta offset with only one of the two codewords. In some such cases, the beta offset is applied with the codeword using the latest largest modulation and coding scheme (MCS) and/or transport block (TB) size to arrive at the number of resources used for multiplexing UCI into each of the two codewords. In other such cases, the beta offset is applied with the first-ordered codeword in the pair of codewords to arrive at the number of resources used for multiplexing UCI into each of the two codewords.

In a second option, the number of resources used for multiplexing UCI into each of the two codewords may be determined based on an independent application of the (single) indicated beta offset with each of the two codewords independently.

Taking the case where independent beta offsets are provided in the scheduling DCI (one for each codeword), it may be that a first number of resources used for multiplexing UCI into the first codeword may be determined by applying a first beta offset from the scheduling DCI with the first codeword, and that a second number of resources used for multiplexing UCI into the second codeword may be determined by applying a second beta offset from the scheduling DCI with the second codeword.

### Embodiments with Respect to Scaling Offset Configurations

In some embodiments contemplating a PUSCH having two codewords and sent on more than four layers, one or more scaling factors may be configured by the network (e.g., on a semi-static basis) and used by the UE to scale the codewords. This function may allow the network to further control the number of resources for multiplexing UCIs into the two codewords of the PUSCH (e.g., potentially in addition to other mechanisms for the same as are described herein) through the application of scaling factor to a codeword. It may be that in such cases, a scaling provided by the network is generally applicable across the various possible different UCI types (though other cases where a scaling can be applicable on a per-UCI-type basis are also contemplated).

In embodiments where two codewords are used for a PUSCH with more than 4 layers, for UCI multiplexing on the PUSCH, various options for configuring such scaling factors are contemplated. In a first option, a same (single) scaling factor is configured for use with each of the two codewords of the PUSCH.

In a second option, the network may provide the UE with independent scaling factors, such that a first scaling factor is configured for use with a first codeword of the PUSCH, while a second scaling factor is configured for use with a second codeword of the PUSCH.

### Embodiments with Respect to Multiplexing UCI on One of Two Codewords

In some embodiments contemplating a PUSCH having two codewords and sent on more than four layers, it may be that a wireless communication system is configured to multiplex UCI on only one of the pair of codewords in the PUSCH. In such cases, various options for identifying at the UE which of the two codewords into which to multiplex the UCI, and/or for identifying at the network/base station which of two codewords of a received PUSCH contains the multiplexed UCI, are contemplated.

In a first option, the UCI is only multiplexed on a first-ordered codeword within the pair of codewords of the PUSCH. Accordingly, the UE multiplexes UCI on the first ordered codeword, and the network extracts UCI from the first-ordered codeword.

In a second option, the UCI is multiplexed on the codeword from the pair of codewords of the PUSCH that uses the highest MCS and/or TB size. Accordingly, the UE multiplexes UCI on the codeword using the higher MCS and/or TB size, and the network extracts UCI from the codeword using the higher MCS and/or TB size. Under this option, in the case that each of the two codewords use a same MCS and/or TB size, the UCI may be multiplexed on the first-ordered codeword within the pair of codewords (e.g., as in the first option).

In some embodiments, it may be that a UE supports the multiplexing of UCI on only one of the two codewords of the PUSCH (e.g., in the manner described herein). Under such circumstances, the UE may provide the network with an indication that the UE only supports UCIs multiplexed on one codeword in such contexts.

In some embodiments, it may be that the treatment of UCI in such contexts can depend on a type of the UCI. For example, it may be that the UE and/or the network can determine, based on the type of the UCI, that the UCI is understood to be multiplexed on only the codeword of the pair of codewords in the PUSCH that uses a higher MCS and/or TB size. In some such cases, if the two codewords of the PUSCH use the same MCS and/or TB size, the UCI is understood to be multiplexed on the first-ordered codeword of the pair of codewords. In some example systems, it may be that UCI of a HARQ-ACK type and/or a HARQ-ACK and CG-UCI type may be so configured to be multiplexed on the codeword of the pair of codewords using the higher MCS and/or TB size (and then, for example, if the two codewords use the same MCS and/or TB size, the UCI is multiplexed on the first-ordered codeword of the pair of codewords).

Accordingly, the UE may perform the multiplexing of the UCI with the codeword so identified according to UCI type, and/or the network may extract the UCI from the codeword so identified according to UCI type.

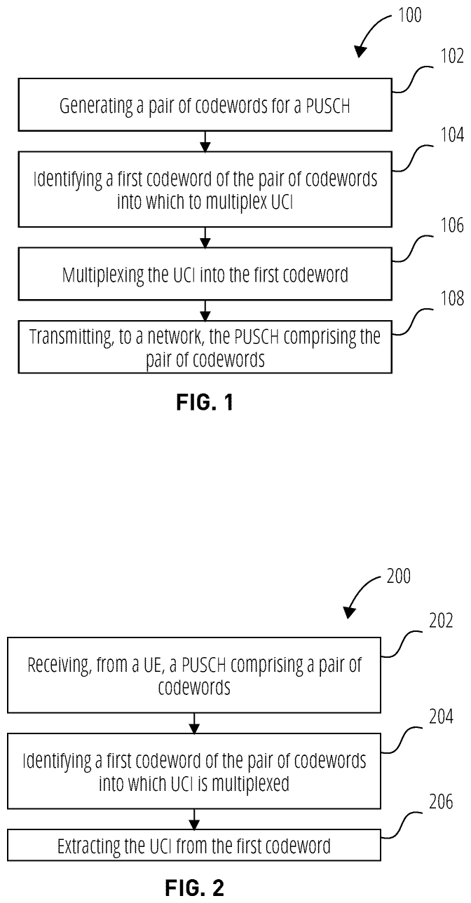

FIG. 1 illustrates a method 100 of a UE, according to embodiments herein. The method 100 includes generating 102 a pair of codewords for a PUSCH. The method 100 further includes identifying 104 a first codeword of the pair of codewords into which to multiplex UCI. The method 100 further includes multiplexing 106 the UCI into the first codeword. The method 100 further includes transmitting 108, to a network, the PUSCH comprising the pair of codewords.

In some embodiments of the method 100, a second codeword of the pair of codewords is not used for UCI multiplexing.

In some embodiments of the method 100, the identifying the first codeword of the pair of codewords into which to multiplex the UCI comprises determining that the first codeword is a first-ordered codeword within the pair of codewords. In some such embodiments, the identifying the first codeword of the pair of codewords into which to multiplex the UCI further comprises determining that the first codeword and a second codeword of the pair of codewords use a same MCS.

In some embodiments of the method 100, the identifying the first codeword of the pair of codewords into which to multiplex the UCI comprises determining that the first codeword uses a higher MCS than a second codeword of the pair of codewords.

In some embodiments, the method 100 further includes transmitting, to the network, an indication that the UE supports UCI multiplexing with respect to a single codeword of the pair of codewords.

In some embodiments of the method 100, the identifying the first codeword of the pair of codewords into which to multiplex the UCI comprises: determining, based on a type of the UCI, to multiplex the UCI into one codeword of the pair of codewords with a highest MCS; and determining that the first codeword uses a higher MCS than a second codeword of the pair of codewords. In some such embodiments, the type of the UCI comprises a HARQ-ACK type.

FIG. 2 illustrates a method 200 of a RAN, according to embodiments herein. The method 200 includes receiving 202, from a UE, a PUSCH comprising a pair of codewords. The method 200 further includes identifying 204 a first codeword of the pair of codewords into which UCI is multiplexed. The method 200 further includes extracting 206 the UCI from the first codeword.

In some embodiments of the method 200, a second codeword of the pair of codewords does not contain multiplexed UCI.

In some embodiments of the method 200, the identifying the first codeword of the pair of codewords into which the UCI is multiplexed comprises determining that the first codeword is a first-ordered codeword within the pair of codewords. In some such embodiments, the identifying the first codeword of the pair of codewords into which the UCI is multiplexed further comprises determining that the first codeword and a second codeword of the pair of codewords use a same MCS.

In some embodiments of the method 200, the identifying the first codeword of the pair of codewords into which the UCI is multiplexed comprises determining that the first codeword uses a higher MCS than a second codeword of the pair of codewords.

In some embodiments, the method 200 further includes receiving, from the UE, an indication that the UE supports UCI multiplexing with respect to a single codeword of the pair of codewords.

In some embodiments of the method 200, the identifying the first codeword of the pair of codewords into which the UCI is multiplexed comprises: determining, based on a type of the UCI, that the UCI is multiplexed into one codeword of the pair of codewords with a highest MCS; and determining that the first codeword uses a higher MCS than a second codeword of the pair of codewords. In some such embodiments, the type of the UCI comprises a HARQ-ACK type.

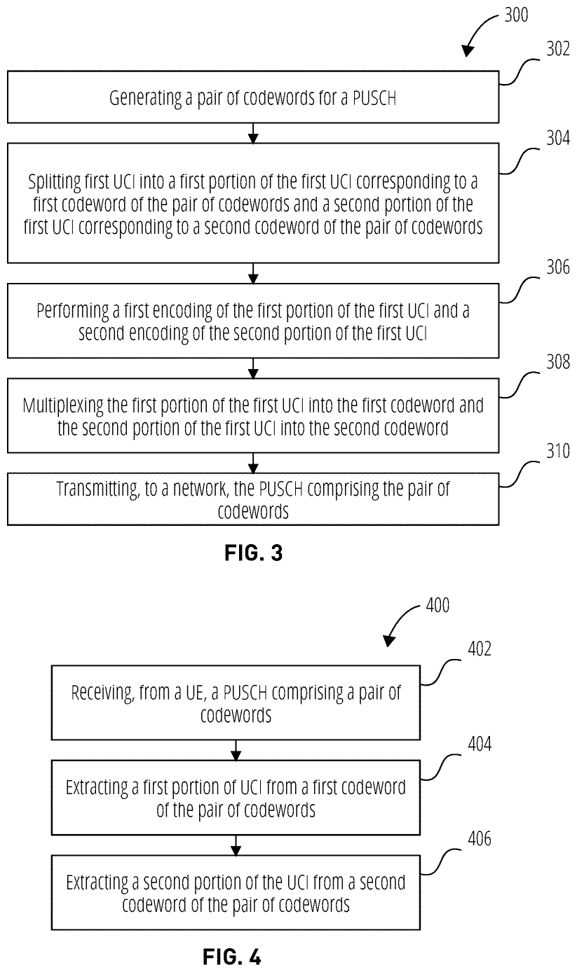

FIG. 3 illustrates a method 300 of a UE, according to embodiments herein. The method 300 includes generating 302 a pair of codewords for a PUSCH. The method 300 further includes splitting 304 first UCI into a first portion of the first UCI corresponding to a first codeword of the pair of codewords and a second portion of the first UCI corresponding to a second codeword of the pair of codewords. The method 300 further includes performing 306 a first encoding of the first portion of the first UCI and a second encoding of the second portion of the first UCI. The method 300 further includes multiplexing 308 the first portion of the first UCI into the first codeword and the second portion of the first UCI into the second codeword. The method 300 further includes transmitting 310, to a network, the PUSCH comprising the pair of codewords.

In some embodiments of the method 300, the determining to split the first UCI into the first portion of the first UCI corresponding to the first codeword and the second portion of the first UCI corresponding to the second codeword is based on a type of the first UCI.

In some embodiments of the method 300, the first encoding comprises polar encoding.

In some embodiments of the method 300, the first encoding comprises simplex encoding.

In some embodiments of the method 300, the splitting first UCI into the first portion of the first UCI corresponding to the first codeword and the second portion of the first UCI corresponding to the second codeword comprises: identifying a first floor (L/2) bits of the first UCI as the first portion of the first UCI; and identifying a last ceil (L/2) bits of the first UCI as the second portion of the first UCI; where L is the length of the first UCI in bits.

In some embodiments of the method 300, the splitting first UCI into the first portion of the first UCI corresponding to the first codeword and the second portion of the first UCI corresponding to the second codeword comprises: identifying a first floor (L*K₁l (K₁+K₂)) bits of the first UCI as the first portion of the first UCI; and identifying a last ceil (L*K₂/(K₁+K₂)) bits of the first UCI as the second portion of the first UCI; where: L is the length of the first UCI in bits; K₁ is a first size corresponding to the first codeword; and K₂ is a second size corresponding to the second codeword. In some such embodiments, K₁ is a first total number of bits of the first codeword and K₂ is a second total number of bits of the second codeword. In some such embodiments, K₁ is a first number of bits for UCI in the first codeword and K₂ is a second number of bits for UCI in the second codeword.

In some embodiments, the method 300 further includes selecting, from among the first UCI and a second UCI, the first UCI to be multiplexed into the PUSCH based on a priority of the first UCI that is higher than a priority of the second UCI.

In some embodiments, the method 300 further includes receiving, from the network, a beta offset corresponding to a type of the first UCI; and computing a number of resources to use for the multiplexing the first portion of the first UCI into the first codeword and for the multiplexing the second portion of the first UCI into the second codeword by applying the beta offset with one of the first codeword and the second codeword. In some such embodiments, the beta offset is received in a DCI that schedules the PUSCH.

In some embodiments, the method 300 further includes receiving, from the network, a beta offset corresponding to a type of the first UCI; computing a first number of resources to use for the multiplexing the first portion of the first UCI into the first codeword by applying the beta offset with the first codeword; and computing a second number of resources to use for the multiplexing the second portion of the first UCI into the second codeword by applying the beta offset with the second codeword. In some such embodiments, the beta offset is received in a DCI that schedules the PUSCH.

In some embodiments, the method 300 further includes receiving, from the network, a first beta offset corresponding to a type of the first UCI and a second beta offset corresponding to the type of the first UCI; computing a first number of resources to use for the multiplexing the first portion of the first UCI into the first codeword by applying the first beta offset with the first codeword; and computing a second number of resources to use for the multiplexing the second portion of the first UCI into the second codeword by applying the second beta offset with the second codeword. In some such embodiments, the first beta offset and the second beta offset are received in a DCI that schedules the PUSCH.

In some embodiments, the method 300 further includes scaling the first codeword and the second codeword according to a scaling factor for each of the first codeword and the second codeword.

In some embodiments, the method 300 further includes scaling the first codeword according to a first scaling factor for the first codeword; and scaling the second codeword according to a second scaling factor for the second codeword.

FIG. 4 illustrates a method 400 of a RAN, according to embodiments herein. The method 400 includes receiving 402, from a UE, a PUSCH comprising a pair of codewords. The method 400 further includes extracting 404 a first portion of UCI from a first codeword of the pair of codewords. The method 400 further includes extracting 406 a second portion of the UCI from a second codeword of the pair of codewords.

In some embodiments, the method 400 further includes providing, to the UE, a beta offset for use with each of the first codeword and the second codeword.

In some embodiments, the method 400 further includes providing, to the UE, a first beta offset for use with the first codeword and a second beta offset for use with the second codeword.

In some embodiments, the method 400 further includes providing, to the UE, a scaling factor for use with each of the first codeword and the second codeword.

In some embodiments, the method 400 further includes providing, to the UE, a first scaling factor for use with the first codeword and a second scaling factor for use with the second codeword.

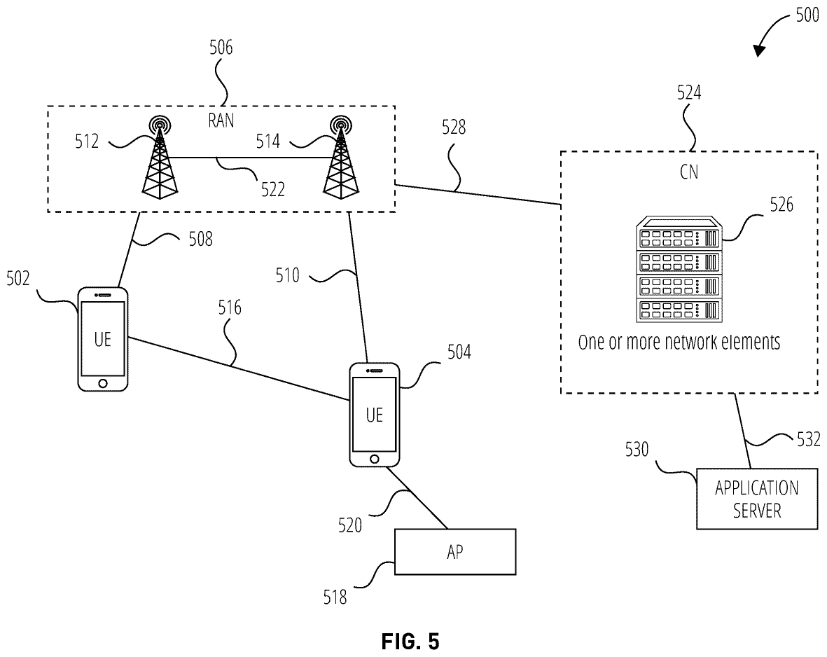

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations (such as base station 512 and base station 514) that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VOIP sessions, group communication sessions, etc.) for the UE 502 and UE 504 via the CN 524. The application server 530 may communicate with the CN 524 through an IP communications interface 532.

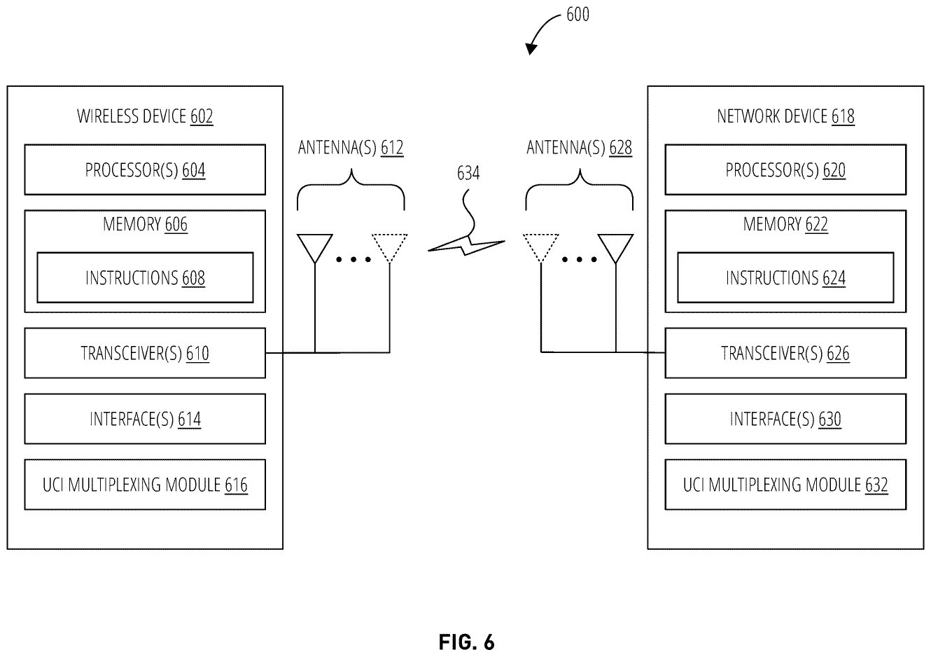

FIG. 6 illustrates a system 600 for performing signaling 634 between a wireless device 602 and a network device 618, according to embodiments disclosed herein. The system 600 may be a portion of a wireless communications system as herein described. The wireless device 602 may be, for example, a UE of a wireless communication system. The network device 618 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter circuitry and/or receiver circuitry that use the antenna(s) 612 of the wireless device 602 to facilitate signaling (e.g., the signaling 634) to and/or from the wireless device 602 with other devices (e.g., the network device 618) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth® and the like).

The wireless device 602 may include a UCI multiplexing module 616. The UCI multiplexing module 616 may be implemented via hardware, software, or combinations thereof. For example, the UCI multiplexing module 616 may be implemented as a processor, circuit, and/or instructions 608 stored in the memory 606 and executed by the processor(s) 604. In some examples, the UCI multiplexing module 616 may be integrated within the processor(s) 604 and/or the transceiver(s) 610. For example, the UCI multiplexing module 616 may be implemented by a combination of software components (e.g., executed by a DSP or a general processor) and hardware components (e.g., logic gates and circuitry) within the processor(s) 604 or the transceiver(s) 610.

The UCI multiplexing module 616 may be used for various aspects of the present disclosure, for example, aspects of any of FIG. 1 through FIG. 4. For example, the UCI multiplexing module 616 may be configured to perform UCI encoding, use beta offset(s) to determine number(s) of resources for codewords, use scaling offset(s), and/or identify and use one of two codewords of a PUSCH into which to multiplex UCI, in the manner that has been described herein.

The network device 618 may include one or more processor(s) 620. The processor(s) 620 may execute instructions such that various operations of the network device 618 are performed, as described herein. The processor(s) 620 may include one or more baseband processors implemented using, for example, a CPU, a DSP, an ASIC, a controller, an FPGA device, another hardware device, a firmware device, or any combination thereof configured to perform the operations described herein.

The network device 618 may include a memory 622. The memory 622 may be a non-transitory computer-readable storage medium that stores instructions 624 (which may include, for example, the instructions being executed by the processor(s) 620). The instructions 624 may also be referred to as program code or a computer program. The memory 622 may also store data used by, and results computed by, the processor(s) 620.

The network device 618 may include one or more transceiver(s) 626 that may include RF transmitter circuitry and/or receiver circuitry that use the antenna(s) 628 of the network device 618 to facilitate signaling (e.g., the signaling 634) to and/or from the network device 618 with other devices (e.g., the wireless device 602) according to corresponding RATs.

The network device 618 may include one or more antenna(s) 628 (e.g., one, two, four, or more). In embodiments having multiple antenna(s) 628, the network device 618 may perform MIMO, digital beamforming, analog beamforming, beam steering, etc., as has been described.

The network device 618 may include one or more interface(s) 630. The interface(s) 630 may be used to provide input to or output from the network device 618. For example, a network device 618 that is a base station may include interface(s) 630 made up of transmitters, receivers, and other circuitry (e.g., other than the transceiver(s) 626/antenna(s) 628 already described) that enables the base station to communicate with other equipment in a core network, and/or that enables the base station to communicate with external networks, computers, databases, and the like for purposes of operations, administration, and maintenance of the base station or other equipment operably connected thereto.

The network device 618 may include a UCI multiplexing module 632. The UCI multiplexing module 632 may be implemented via hardware, software, or combinations thereof. For example, the UCI multiplexing module 632 may be implemented as a processor, circuit, and/or instructions 624 stored in the memory 622 and executed by the processor(s) 620. In some examples, the UCI multiplexing module 632 may be integrated within the processor(s) 620 and/or the transceiver(s) 626. For example, the UCI multiplexing module 632 may be implemented by a combination of software components (e.g., executed by a DSP or a general processor) and hardware components (e.g., logic gates and circuitry) within the processor(s) 620 or the transceiver(s) 626.

The UCI multiplexing module 632 may be used for various aspects of the present disclosure, for example, aspects of FIG. 1 through FIG. 4. For example, the UCI multiplexing module 632 may be configured to extract portions of UCI from each of two codewords of a received PUSCH, and/or to identify one of two codewords of a PUSCH into which UCI has been multiplexed and extract such UCI, in the manner that has been described herein.

Embodiments contemplated herein include an apparatus comprising means to perform one or more elements of any of the method 100 and the method 300. This apparatus may be, for example, an apparatus of a UE (such as a wireless device 602 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 100 and the method 300. This non-transitory computer-readable media may be, for example, a memory of a UE (such as a memory 606 of a wireless device 602 that is a UE, as described herein).

Embodiments contemplated herein include an apparatus comprising logic, modules, or circuitry to perform one or more elements of any of the method 100 and the method 300. This apparatus may be, for example, an apparatus of a UE (such as a wireless device 602 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 100 and the method 300. This apparatus may be, for example, an apparatus of a UE (such as a wireless device 602 that is a UE, as described herein).

Embodiments contemplated herein include a signal as described in or related to one or more elements of any of the method 100 and the method 300.

Embodiments contemplated herein include a computer program or computer program product comprising instructions, wherein execution of the program by a processor is to cause the processor to carry out one or more elements of any of the method 100 and the method 300. The processor may be a processor of a UE (such as a processor(s) 604 of a wireless device 602 that is a UE, as described herein). These instructions may be, for example, located in the processor and/or on a memory of the UE (such as a memory 606 of a wireless device 602 that is a UE, as described herein).

Embodiments contemplated herein include an apparatus comprising means to perform one or more elements of any of the method 200 and the method 400. This apparatus may be, for example, an apparatus of a base station (such as a network device 618 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 200 and the method 400. This non-transitory computer-readable media may be, for example, a memory of a base station (such as a memory 622 of a network device 618 that is a base station, as described herein).

Embodiments contemplated herein include an apparatus comprising logic, modules, or circuitry to perform one or more elements of any of the method 200 and the method 400. This apparatus may be, for example, an apparatus of a base station (such as a network device 618 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 200 and the method 400. This apparatus may be, for example, an apparatus of a base station (such as a network device 618 that is a base station, as described herein).

Embodiments contemplated herein include a signal as described in or related to one or more elements of any of the method 200 and the method 400.

Embodiments contemplated herein include a computer program or computer program product comprising instructions, wherein execution of the program by a processing element is to cause the processing element to carry out one or more elements of any of the method 200 and the method 400. The processor may be a processor of a base station (such as a processor(s) 620 of a network device 618 that is a base station, as described herein). These instructions may be, for example, located in the processor and/or on a memory of the base station (such as a memory 622 of a network device 618 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
generating a pair of codewords for a physical uplink shared channel (PUSCH);
identifying a first codeword of the pair of codewords into which to multiplex uplink control information (UCI);
multiplexing the UCI into the first codeword; and
transmitting, to a network, the PUSCH comprising the pair of codewords.

2. The method of claim 1, wherein a second codeword of the pair of codewords is not used for UCI multiplexing.

3. The method of claim 1, wherein the identifying the first codeword of the pair of codewords into which to multiplex the UCI comprises determining that the first codeword is a first-ordered codeword within the pair of codewords.

4. The method of claim 3, wherein the identifying the first codeword of the pair of codewords into which to multiplex the UCI further comprises determining that the first codeword and a second codeword of the pair of codewords use a same modulation and coding scheme (MCS).

5. The method of claim 1, wherein the identifying the first codeword of the pair of codewords into which to multiplex the UCI comprises determining that the first codeword uses a higher modulation and coding scheme (MCS) than a second codeword of the pair of codewords.

6. The method of claim 1, further comprising transmitting, to the network, an indication that the UE supports UCI multiplexing with respect to a single codeword of the pair of codewords.

7. The method of claim 1, wherein the identifying the first codeword of the pair of codewords into which to multiplex the UCI comprises:
determining, based on a type of the UCI, to multiplex the UCI into one codeword of the pair of codewords with a highest modulation and coding scheme (MCS); and
determining that the first codeword uses a higher MCS than a second codeword of the pair of codewords.

8. The method of claim 7, wherein the type of the UCI comprises a hybrid automatic repeat request acknowledgment (HARQ-ACK) type.

9. A method of a radio access network (RAN), comprising:
receiving, from a user equipment (UE), a physical uplink shared channel (PUSCH) comprising a pair of codewords;
identifying a first codeword of the pair of codewords into which uplink control information (UCI) is multiplexed; and
extracting the UCI from the first codeword.

10. The method of claim 9, wherein a second codeword of the pair of codewords does not contain multiplexed UCI.

11. The method of claim 9, wherein the identifying the first codeword of the pair of codewords into which the UCI is multiplexed comprises determining that the first codeword is a first-ordered codeword within the pair of codewords.

12. The method of claim 11, wherein the identifying the first codeword of the pair of codewords into which the UCI is multiplexed further comprises determining that the first codeword and a second codeword of the pair of codewords use a same modulation and coding scheme (MCS).

13. The method of claim 9, wherein the identifying the first codeword of the pair of codewords into which the UCI is multiplexed comprises determining that the first codeword uses a higher modulation and coding scheme (MCS) than a second codeword of the pair of codewords.

14. The method of claim 9, further comprising receiving, from the UE, an indication that the UE supports UCI multiplexing with respect to a single codeword of the pair of codewords.

15. The method of claim 9, wherein the identifying the first codeword of the pair of codewords into which the UCI is multiplexed comprises:
determining, based on a type of the UCI, that the UCI is multiplexed into one codeword of the pair of codewords with a highest modulation and coding scheme (MCS); and
determining that the first codeword uses a higher MCS than a second codeword of the pair of codewords.

16. The method of claim 15, wherein the type of the UCI comprises a hybrid automatic repeat request acknowledgment (HARQ-ACK) type.

17. A method of a user equipment (UE), comprising:
generating a pair of codewords for a physical uplink shared channel (PUSCH);
splitting first uplink control information (UCI) into a first portion of the first UCI corresponding to a first codeword of the pair of codewords and a second portion of the first UCI corresponding to a second codeword of the pair of codewords;
performing a first encoding of the first portion of the first UCI and a second encoding of the second portion of the first UCI;
multiplexing the first portion of the first UCI into the first codeword and the second portion of the first UCI into the second codeword; and
transmitting, to a network, the PUSCH comprising the pair of codewords.

18. The method of claim 17, wherein the determining to split the first UCI into the first portion of the first UCI corresponding to the first codeword and the second portion of the first UCI corresponding to the second codeword is based on a type of the first UCI.

19. The method of claim 17, wherein the first encoding comprises polar encoding.

20. The method of claim 17, wherein the first encoding comprises simplex encoding.

21-42. (canceled)
